(19) United States
(12) Patent Application Publication
(10) Pub. No.: US 2026/0093853 A1
(43) Pub. Date: Apr. 2, 2026

(54) MEMORY SAFETY USING CRYPTOGRAPHIC ENTROPY TAGGING

(71) Applicant: Intel Corporation, Santa Clara, CA (US)

(72) Inventors: Bharath Namboothiry, Portland, OR (US); David M. Durham, Beaverton, OR (US); Christoph Dobraunig, St. Veit an der Glan (AT); Michael LeMay, Hillsboro, OR (US)

(73) Assignee: Intel Corporation, Santa Clara, CA (US)

(21) Appl. No.: 18/900,705

(22) Filed: Sep. 28, 2024

(51) Int. Cl. G06F 21/78; G06F 21/57; G06F 21/60

(52) U.S. Cl. CPC G06F 21/78; G06F 21/577; G06F 21/604

(57) ABSTRACT

Techniques for memory safety using cryptographic entropy tagging are described. In an embodiment, an apparatus includes a plurality of decryption circuits and an entropy comparison circuit. The plurality of decryption circuits are to decrypt content of a memory location to be referenced by a pointer used in an attempted access to the memory location, the pointer to include a supplied tag value, wherein the supplied tag value is one of a plurality of possible tag values, and wherein each of the plurality of decryption circuits is to decrypt the content of the memory location based on a different one of the plurality of possible tag values to generate a plurality of decryption results. The entropy comparison circuit is to determine whether the attempted access is valid by measuring entropy of at least one of the plurality of decryption results and comparing the entropy of the at least one of the plurality of decryption results to the entropy of at least an other one of the plurality of decryption results or a threshold value.

### STATEMENT REGARDING FEDERALLY SPONSORED RESEARCH AND DEVELOPMENT

This invention was made with Government support under Agreement No. N66001-23-9-4004, awarded by Naval Information Warfare Center Pacific and funded by the Defense Advanced Research Project Agency. The Government has certain rights in the invention.

### BACKGROUND

Computers and other information processing systems may store confidential, private, and secret information in their memories. Software may have vulnerabilities that may be exploitable to steal such information. Data corruption is also a risk. Hardware may also have vulnerabilities that may be exploited and/or adversaries may physically modify a system to steal information. Therefore, memory safety and security are important concerns in computer system architecture and design.

### BRIEF DESCRIPTION OF DRAWINGS

Various examples in accordance with the present disclosure will be described with reference to the drawings, in which:

FIG. 1 illustrates an apparatus for memory safety using cryptographic entropy tagging according to an embodiment.

FIG. 2A illustrates a method for memory safety using cryptographic entropy tagging according to an embodiment.

FIG. 2B illustrates a method for memory safety using cryptographic entropy tagging according to an embodiment.

FIG. 2C illustrates a method for memory safety using cryptographic entropy tagging according to an embodiment.

FIG. 3A illustrates an example graph for tuning parameters for cryptographic entropy tagging according to an embodiment.

FIG. 3B illustrates an example graph for tuning parameters for cryptographic entropy tagging according to an embodiment.

FIG. 3C illustrates example equations for tuning parameters for cryptographic entropy tagging according to an embodiment.

FIG. 3D illustrates an example graph for tuning parameters for cryptographic entropy tagging according to an embodiment.

FIG. 4 illustrates an example computing system according to an embodiment.

FIG. 5 illustrates a block diagram of an example processor and/or System on a Chip (SoC) that may have one or more cores and an integrated memory controller according to an embodiment.

FIG. 6A is a block diagram illustrating both an example in-order pipeline and an example register renaming, out-of-order issue/execution pipeline according to an embodiment.

FIG. 6B is a block diagram illustrating both an example in-order architecture core and an example register renaming, out-of-order issue/execution architecture core to be included in a processor according to an embodiment.

FIG. 7 illustrates examples of execution unit(s) circuitry according to an embodiment.

FIG. 8 illustrates the use of a software instruction converter to convert binary instructions in a source instruction set architecture to binary instructions in a target instruction set architecture according to an embodiment.

### DETAILED DESCRIPTION

The present disclosure relates to methods, apparatus, systems, and non-transitory computer-readable storage media for memory safety using cryptographic entropy tagging. A feature or features supported by or implemented in a system, processor, etc. according to embodiments may be referred to as cryptographic entropy tagging, etc. According to some examples, an apparatus includes a plurality of decryption circuits and an entropy comparison circuit. The plurality of decryption circuits are to decrypt content of a memory location to be referenced by a pointer used in an attempted access to the memory location, the pointer to include a supplied tag value, wherein the supplied tag value is one of a plurality of possible tag values, and wherein each of the plurality of decryption circuits is to decrypt the content of the memory location based on a different one of the plurality of possible tag values to generate a plurality of decryption results. The entropy comparison circuit is to determine whether the attempted access is valid by measuring entropy of at least one of the plurality of decryption results and comparing the entropy of the at least one of the plurality of decryption results to the entropy of at least an other one of the plurality of decryption results or a threshold value.

As mentioned in the background section, memory safety and security are important concerns in computer system architecture and design. Some approaches to providing memory safety (e.g., ARM Memory Tagging Extension (MTE), Intel® Memory Tagging Technology (MTT), etc., which may be referred to as memory tagging) involve associating (e.g., to indicate ownership) a first tag (or other metadata) with a memory location (e.g., by storing the first tag in the memory location alongside data, by storing the first tag in a table or other data structure indexed by an address of the memory location); comparing, to the first tag, a second tag (or other metadata) in an address pointer to the memory location in connection with an attempted access to the memory location; and allowing access to the memory location only if the second tag matches the first tag.

However, tag storage and comparison operations introduce additional area and performance costs. Therefore, a cryptographic entropy tagging capability that may be provided by embodiments may be desired. For example, embodiments may reduce or eliminate tag storage and comparison by, instead, inferring integrity from data characteristics, as described below. Use of embodiments may mitigate both memory safety vulnerabilities and physical data corruption with a single, unified mechanism. Embodiments may provide integrity checking with little or no state, with a tunable tradeoff between efficacy and overhead.

Embodiments may include using cryptographic entropy tagging instead of or in connection with other memory safety techniques in various usage scenarios. For example, embodiments may include synchronous/precise tag checking (e.g., memory tagging as described above) used selectively when desired to detect false negatives (e.g., detecting missing some memory safety violations) that may be exhibited with cryptographic entropy tagging alone.

In embodiments, a cryptographic pointer is used to decrypt content of memory locations. Included in the cryptographic pointers is a n-bit tag value which may be set upon allocation of the memory location. For any given memory address, there are 2ⁿ potentially valid cryptographic pointers—precisely one for each possible tag value.

Tag values may be used as cryptographic tweaks, identifiers of cryptographic keys, addresses or indices to locate cryptographic keys or tweaks, etc. for encrypting data to be stored in memory locations referenced by the cryptographic pointers, thus binding the resulting cipertext to the cryptographic pointer and tag. Therefore, only a cryptographic pointer containing the valid (assigned) tag will be able to successfully decrypt content of the corresponding memory location. A pointer possessing any other tag will yield uniformly random bytes with probabilistically high entropy. This property implies among all possible tag decryptions, only the valid decryption will display low entropy. At a high level, embodiments include trying to decrypt using multiple tag values and comparing the respective decryptions'entropy to conclude if the correct tag was used—eliminating the need to store explicit tags for every memory allocation.

Embodiments may be used to catch memory accesses using pointers with incorrect tag values. On each memory access, content (e.g., one or more bytes of data) of a memory location referenced by a pointer is parallelly decrypted using the supplied tag and each other possible tag value. Then, the entropy of the value resulting from decryption with the supplied tag is compared against each of the other values to determine the validity of the access. In embodiments, when a data value is written that would lead to false positives on subsequent reads, the corresponding tag value is stored in an auxiliary lookup table to allow avoiding false positives.

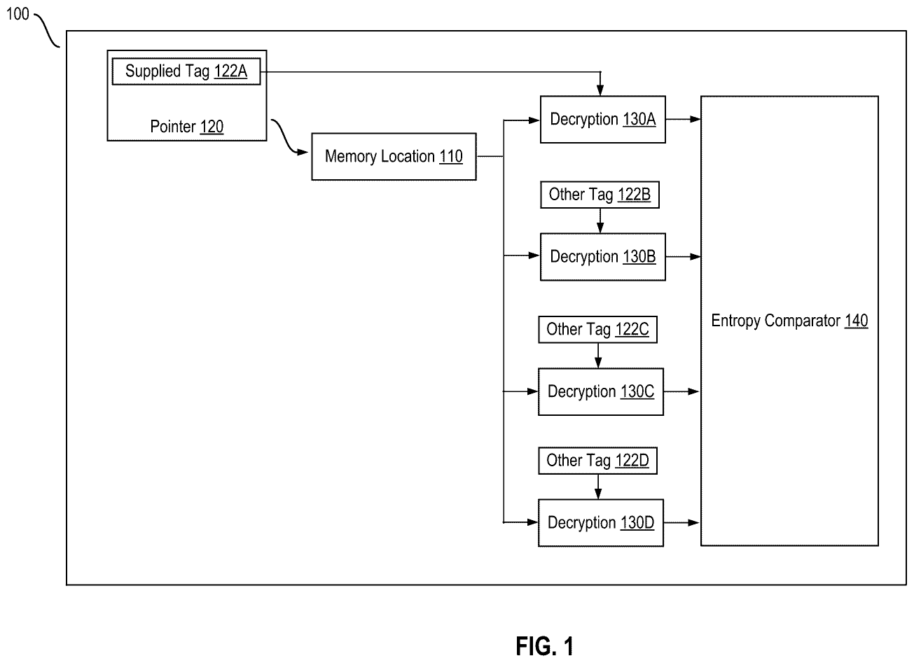

For example, FIG. 1 illustrates an apparatus 100 according to an embodiment. For simplicity of illustration, FIG. 1 shows only four possible tag values (i.e., n=2). Ciphertext in memory location 110, referenced by pointer 120 including supplied tag value 122A, is decrypted by decryption blocks 130A, 130B, 130C, and 130D based on supplied tag value 122A, other possible tag value 122B, other possible tag value 122C, and other possible tag value 122D, respectively. Entropy comparator 140 measures and/or compares the entropy of results from the decryption blocks (e.g., compares the entropy of decryption results to each other and/or to one or more thresholds), as further described below.

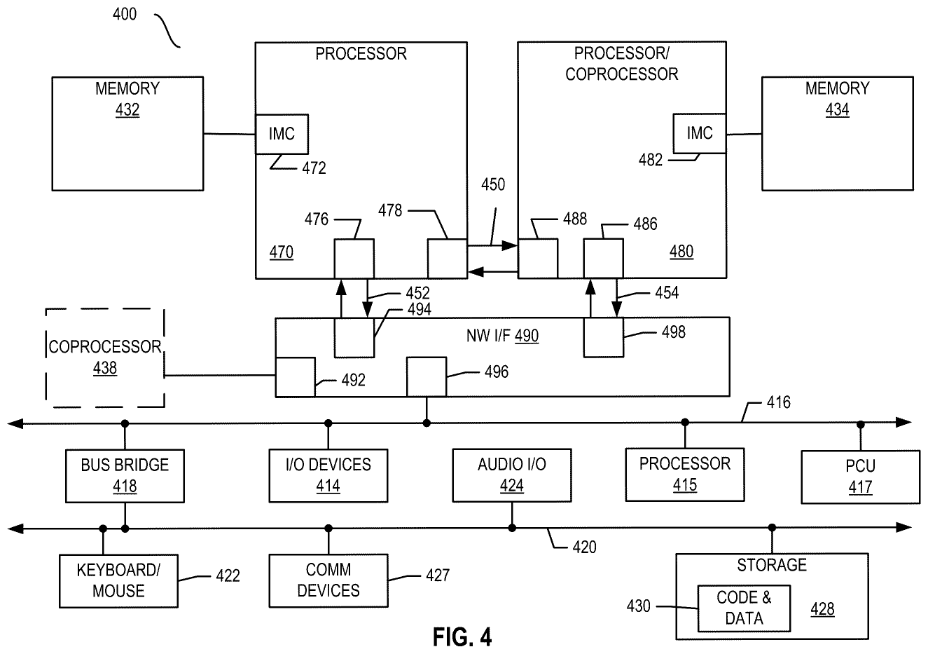

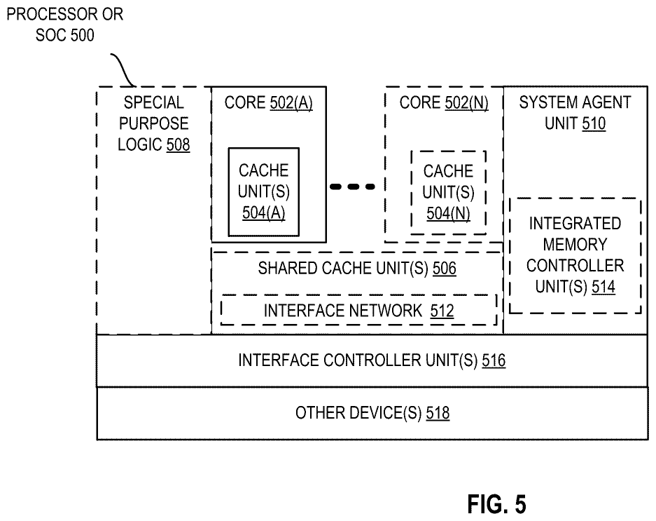

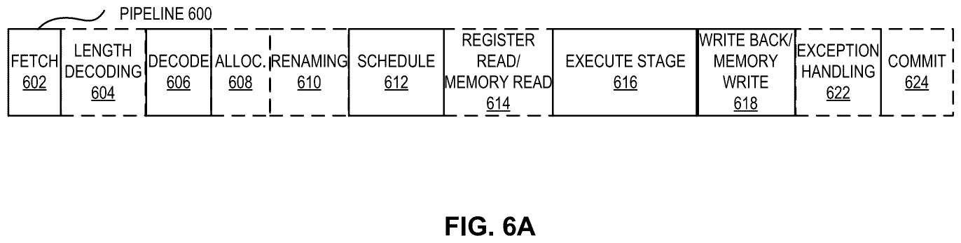

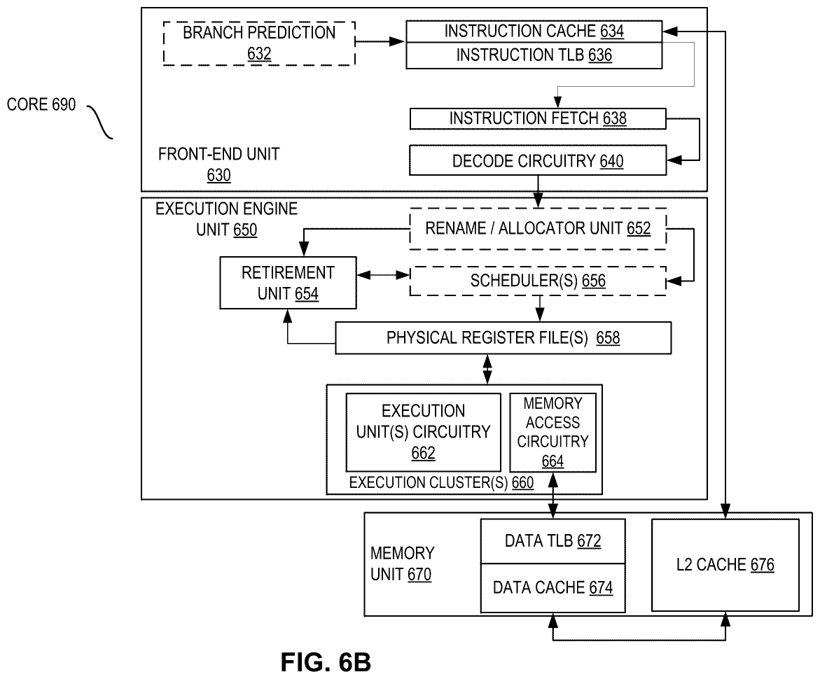

Apparatus 100 may be implemented in a processor, processor core, execution core, etc. which may be any type of processor/core, including a general-purpose microprocessor/core, such as a processor/core in the Intel® Core® Processor Family or other processor family from Intel® Corporation or another company, a special purpose processor or microcontroller, or any other device or component in an information processing system in which an embodiment may be implemented. For example, apparatus 100 may be implemented in any of processors 470, 480, or 415 in FIG. 4, processor or system-on-a-chip (SoC) 500 or one of cores 502A to 502N in FIG. 5, and/or core 690 in FIG. 6B, each as described below, in circuitry, logic gates, structures, hardware, etc., all or parts of which may be included in a discrete component and/or integrated into the circuitry of a processing device or any other apparatus in a computer or other information processing system.

### Allocator Assumptions

Embodiments may include making assumptions about memory allocations. For example, cachelines (e.g., of a fixed size such as 64 bytes) may be split into granules of fixed size g (where g is a divisor of the cacheline size) for the purpose of checking entropy of data decrypted from each of those granules, with the assumption that the memory allocator adheres to the following constraints:
Allocation Granularity: Memory is allocated in multiples of the granule size g to ensure that each allocation is a whole number of granules, without any partial granule allocations.
Alignment Constraint: Each allocated memory block is aligned to start at a granule boundary.

These assumptions imply that the starting address of an allocated block modulo the granule size g equals zero. Therefore, the alignment of allocations coincides with the boundaries of granules, which themselves are subdivisions of the cache line.

These assumptions also allow identification of the boundaries of granules from callback information using pointer arithmetic. In implementations, these assumptions may be enforced using a shim layer.

In some implementations as described above, a fixed granularity is enforced. However, granularities may be dynamic in other implementations. Each allocation may have an assigned granularity, which respects the above constraints. Granularity information may be encoded in the pointer, such that the right method of entropy testing is applied. Dynamically choosing granularity could improve efficacy on larger allocations, while keeping overhead low for smaller allocations.

### Threshold-Based Entropy Protocol

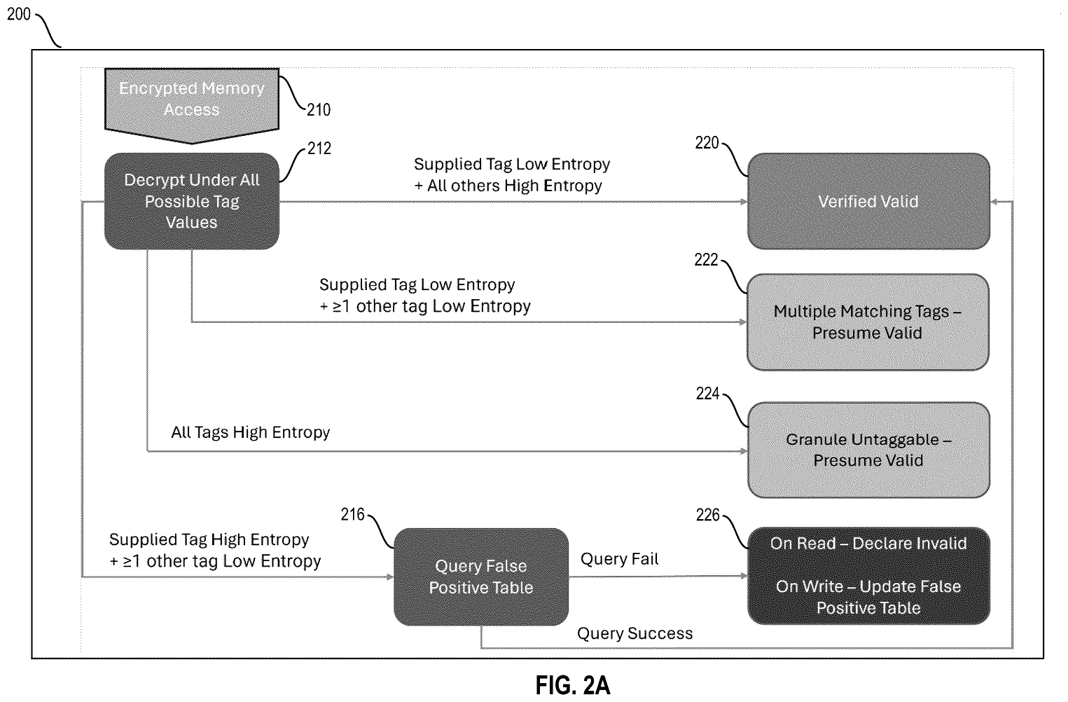

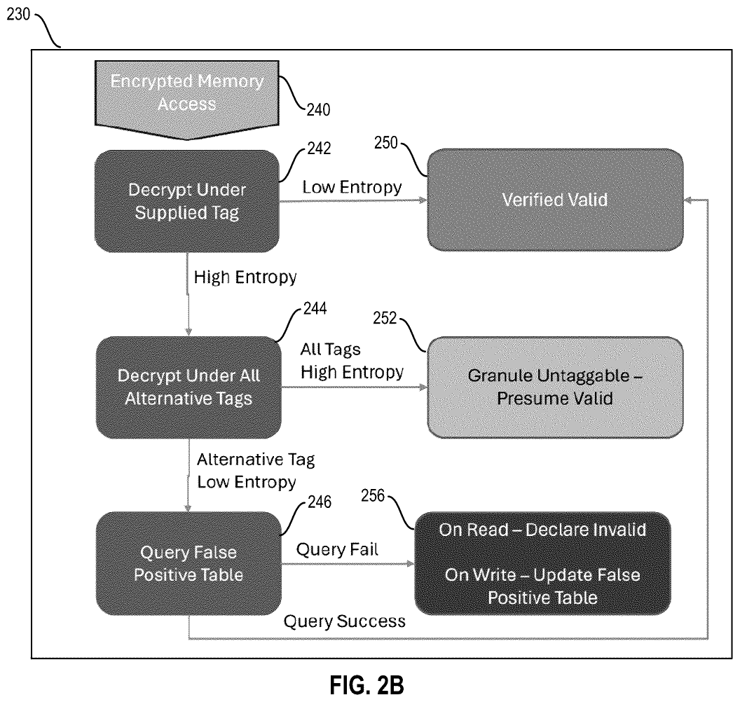

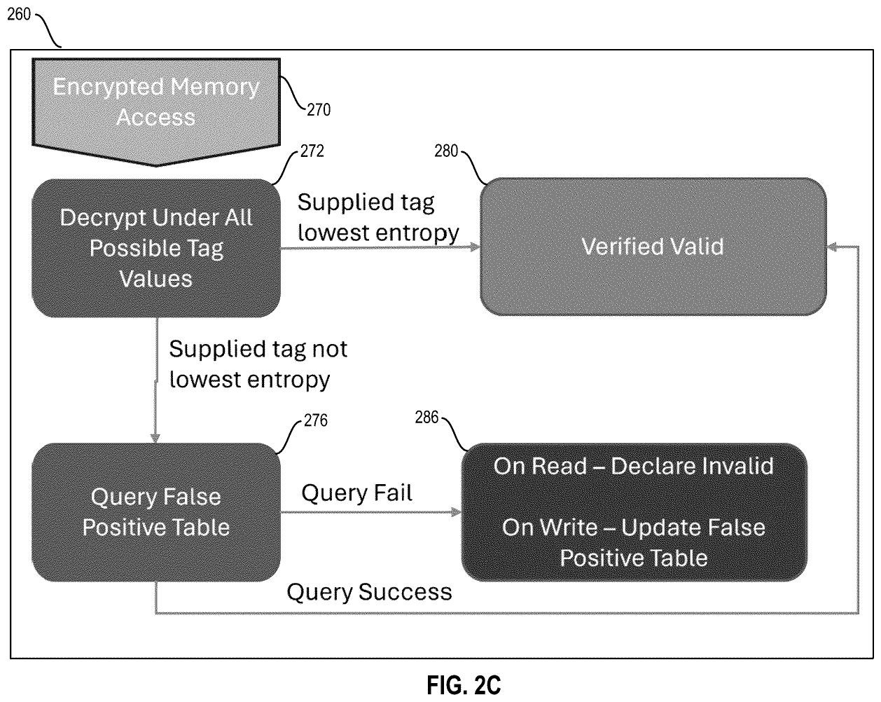

Using the above allocator assumptions, every memory access may be isolated to a constant-size memory granule fully encrypted using the valid tag. For every memory access, the entropy of the granule decrypted under all tag values may be measured. In embodiments, there are four outcomes for each memory granule access, each with a different interpretation, as illustrated in method 200 in FIG. 2A.

In 210 of method 200, an encrypted memory access is attempted. In 212, content (e.g., one or more bytes of data) of the memory location is parallelly decrypted using the supplied tag and each other possible tag value. Then, the entropy of the value resulting from decryption with the supplied tag is compared against each of the other values to determine the validity of the access based on the outcome, as described below.

Outcome 1: The supplied tag decryption was low entropy, and all others were high entropy, which is a strong indication that the access is valid, so it is considered verified valid in 220.

Outcome 2: The supplied tag was among multiple low entropy decryptions. In this case, more than one supplied tag appears to be valid. Here the test is ambiguous, so the supplied tag is presumed valid in 222.

Outcome 3: All decryptions, including the supplied tag, are high entropy. This case will occur if the true decryption of the granule is itself high entropy. In this instance, the test is ambiguous, so the supplied tag is presumed valid in 224.

Outcome 4 (shown as 226): The supplied tag decryption was high entropy, and some other decryption was low entropy. If this outcome is encountered after performing a write, the address of the granule as well as the valid tag used in the write are stored in an auxiliary False Positive table in 226. If this outcome is encountered during a read or before a write, the False Positive table is queried in 216. If the query is unsuccessful, an invalid access is reported in 226. If the query is successful, the access is considered verified valid in 220.

Note that the probability of a false positive (outcome 4) occurring is small as a virtue of the entropy of random counter mode—so the expected size of the table is small, which allows the scheme to be quasi-stateless. In embodiments with tunable parameters, the probability of a false positive may be made negligible by trading off with efficacy, allowing full statelessness. In contrast to traditional memory tagging, this situational table lookup may provide a significant performance improvement.

### Entropy Thresholds

As mentioned above, schemes in embodiments may rely on differentiating between uniformly random granule decryptions and real workload data. For this purpose, embodiments may include various types of entropy tests. For example:
Byte Collisions—Count the number of duplicate bytes in a granule. If the number falls below a pre-tuned threshold, return high entropy. Else, return low entropy. As it is the most intuitive test for entropy, implementations may begin with byte collisions.
Nibble Collisions—Count the number of duplicate nibbles in a granule. If the number falls within a pre-tuned range, return high entropy. Else, return low entropy.
Bit Collisions—Count the number of binary 1's in a granule. If the number falls within a pre-tuned range, return high entropy. Else, return low entropy.
Compression Techniques—Apply principles of memory pattern detection. For example, generating a dictionary for a particular workload or category of workloads may lead to improved recognition of patterns that are common for those workloads.
Folded XOR Hamming Weight Tests—Some data types exhibit patterns in portions of their data units, and those may be detected by XOR-ing multiple data units together and then checking whether the hamming weight of the result is significantly lower than 50%. For example, ASCII characters mostly have unset most-significant bits within their byte-sized data units. Another example is that 64-bit pointers typically have a sign-extension/canonicality field in their most significant bits. Integer data types commonly contain small numbers, which also leads to many of their most-significant bits being used for sign extension.

For the threshold-based test, the chosen threshold has a significant impact on the efficacy of the scheme. If the threshold is set too low, invalid decryptions are more likely to appear with low entropy, leading to more inconclusive results (outcome 2). Conversely, if the threshold is set too high, true decryptions will more easily register as high entropy, leading to more inconclusive results (outcome 3).

Therefore, embodiments may include observing the outcome distribution over different thresholds to tune the threshold and determine a sweet spot. For example, tuning parameters may include:
LEN_GRANULE (Granule Length)
NUM_TAGS (Number of Tags (2\hat{ } Tag Length))
THRESHOLD (Entropy Test+Threshold)

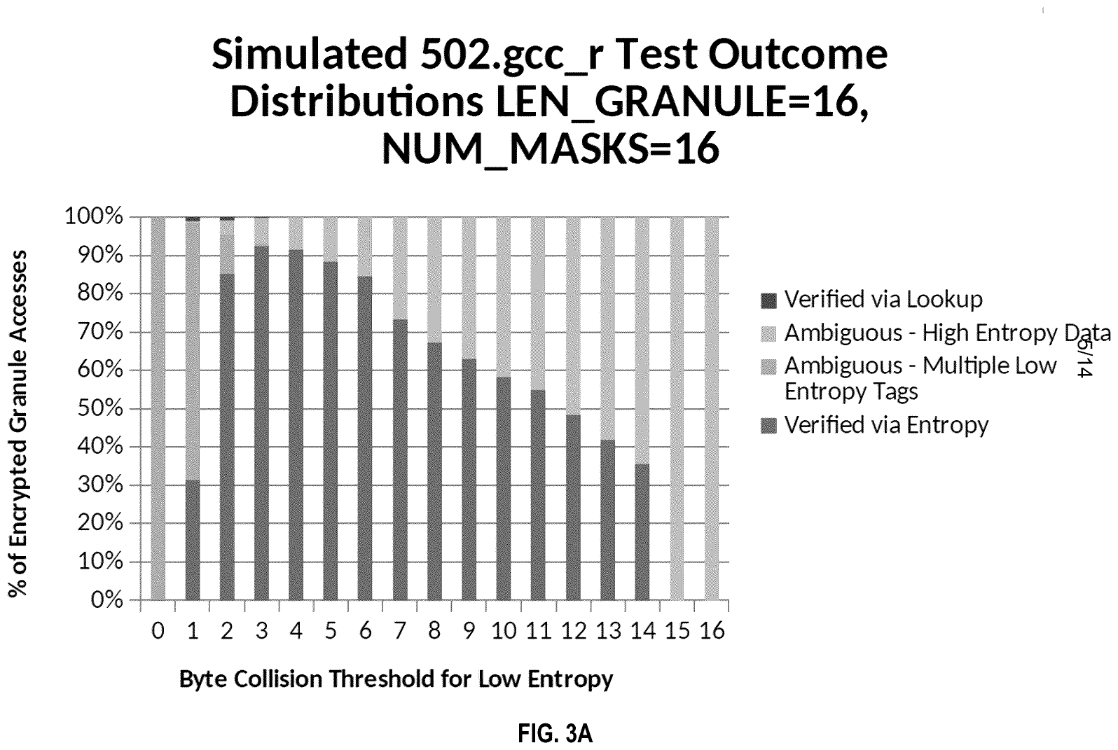

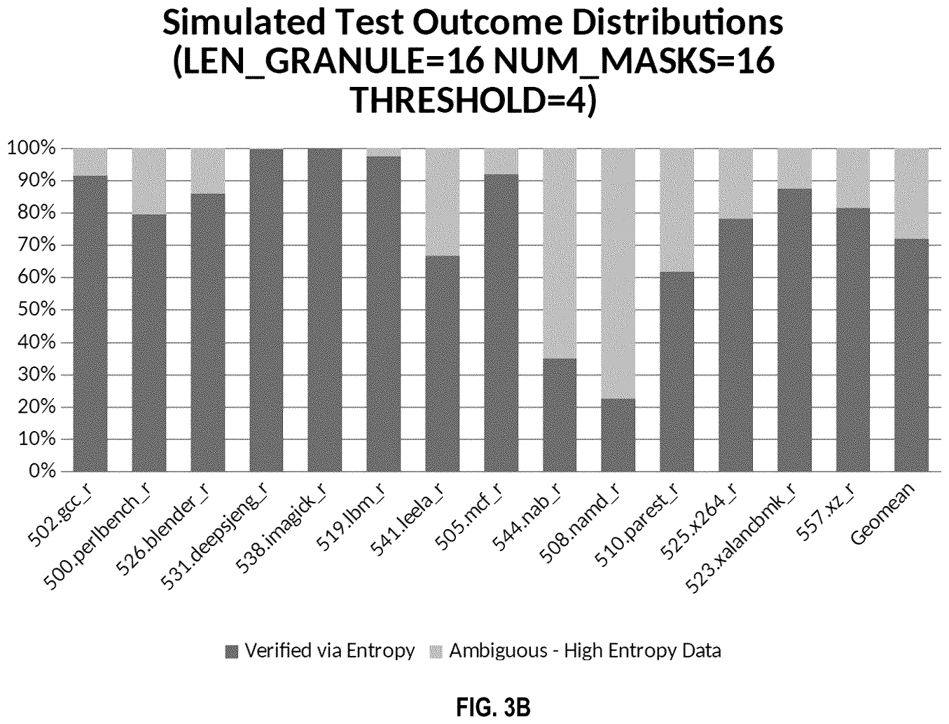

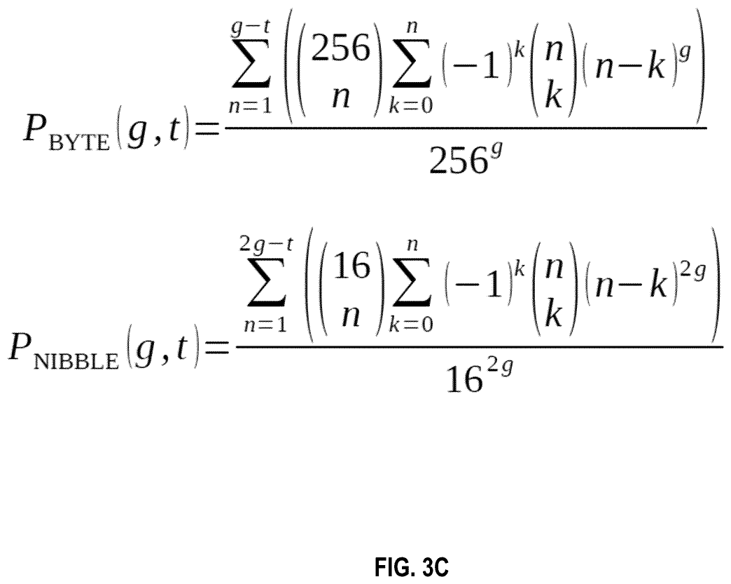

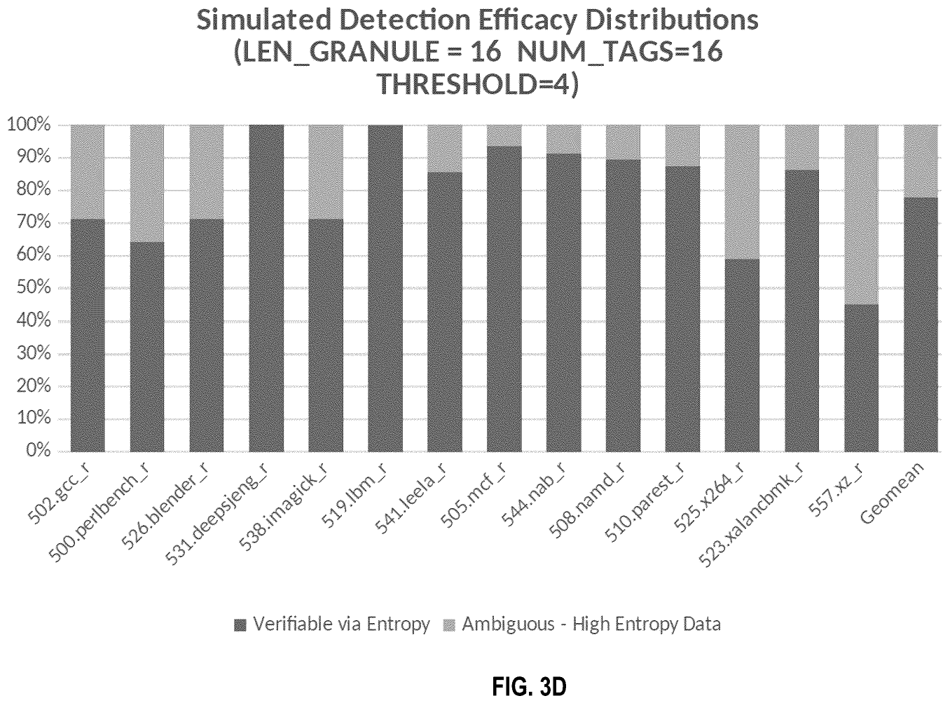

Such an approach may be based on byte collision entropy testing. For example, FIG. 3A shows outcome distribution results generated for different combinations of parameters on the gcc17 workload. Ambiguous cases peak at low and high thresholds. The ideal results are where the ‘Verified via Entropy’ case (marked in blue) represents an overwhelming majority of granule accesses. A threshold of ¼ the granule length seems to attain the best efficacy per combination. Across all combinations, false positive lookups are negligible, hence causing the “Verified by Lookup” data series in the graph to be nearly invisible, in turn resulting in minimal storage and performance overheads, since only the “Lookup Required”cases require loading state from memory during checks.

Given the additional overhead associated with larger granule sizes and more tags, LEN_GRANULE=16 and NUM_TAGS=16, THRESHOLD=4 may be chosen as the most optimal configuration. The tradeoffs between various threshold values are visible in FIG. 3A for that granularity and tag count.

FIG. 3B illustrates the performance of this configuration across multiple SPEC2017 workloads. As may be expected, high entropy workloads such as namd17 have poor efficacy due to much of the data being untaggable. Embodiments may include a potential workaround via relative entropy testing as described below.

### Alternative: Verification Protocol Shortcut

From the protocol discussed above, the case where the supplied decryption is among multiple low entropy decryptions as an ambiguous case may be separated out by attempting to avoid it via threshold tuning.

However, for a given threshold entropy test, the probability that an incorrect decryption (uniformly random granule) passes the entropy test may be computed. For example, in the case of byte collisions and nibble collisions, the probabilities (P_{BYTE} and P_{NIBBLE}, respectively) that an incorrect decryption of granularity g falls over a threshold of t may be expressed as shown in FIG. 3C.

Therefore, rather than setting the threshold based on its tuned performance, a threshold that gives a desired probability may be selected. If the probability is sufficiently low, any memory access displaying low entropy may be approved with confidence. Given the chosen entropy test and granularity, the threshold may be set based on the desired level of confidence. Increasing the threshold beyond the desired level of confidence leads to more frequent high entropy measurements on valid data, reducing the efficacy of our scheme.

This observation allows a shortcut in the protocol, as shown in method 230 in FIG. 2B. In 240 of method 230, an encrypted memory access is attempted. In 242, content (e.g., one or more bytes of data) of the memory location is decrypted using the supplied tag and measuring its entropy. If the entropy is low, then the access is verified valid in 250. If the entropy is high, method 230 continues in 244 (e.g., as in method 200, decrypting based on the alternative (i.e., other possible) tag values, then querying and updating the false positive table if necessary).

In 244, the content of the memory location is parallelly decrypted using each of the alternative tag values. If all decryptions (including the supplied tag) are high entropy, then the granule is untaggable and the supplied tag is presumed valid in 252. If decryption based on an alternative tag results in low entropy, then, after performing a write, the address of the granule as well as the valid tag used in the write are stored in an auxiliary False Positive table in 256, but during a read or before a write, the False Positive table is queried in 246. If the query is unsuccessful, an invalid access is reported in 256. If the query is successful, the access is considered verified valid in 250.

While the detection results in methods 200 and 230 may be identical, the shortcut approach on method 230 may allow for more fundamental threshold selection and possible performance advantages from less decryption.

For a granularity of g=16, and a byte threshold of t=4 (the optimal byte-based configuration for the earlier discussed scheme), P_{BYTE}(g, t)=0.0005. These parameters may be used to test the efficacy of the scheme, as they balance a low probability of incorrect access passing the test with the practicality of the test on valid accesses.

The experiments described above may primarily aim to evaluate the frequency of state lookups that would be needed, which relates to performance. Also, an important efficacy metric, the likelihood of a buggy or malicious memory access being detected, may be evaluated. To measure efficacy in this way, the verifiability status of every active encrypted granule as a time series over the first one billion memory accesses of various SPEC CPU2017 workloads may be recorded. For example, the geometric mean for each workloads time series is depicted in FIG. 3D. Here again, the probabilistic behavior of the scheme causes false positive lookups to be negligible. Therefore, this outcome is omitted from the geometric mean calculations and the graph. A higher proportion of verifiable granules contributes to increased efficacy.

### Another Alternative: Relative Entropy Protocol

A drawback of the previously defined scheme is that it is unable to draw conclusions on high entropy data, because it leverages entropy tests to sort memory into high/low entropy, which renders the scheme inconclusive when all decryptions appear with high entropy. As an alternative, a scheme, illustrated for example as method 260 in FIG. 2C, may directly compare decryptions.

In 270 of method 260, an encrypted memory access is performed. In 272, content (e.g., one or more bytes of data) of the memory location is parallelly decrypted based on all possible tag values (including the supplied tag), and entropy metrics calculated with the expectation that the correct tag's decryption will have the lowest entropy. Therefore, if the supplied tag results in the lowest entropy, the access is considered verified valid in 280. If not, then, after performing a write, the address of the granule as well as the valid tag used in the write are stored in an auxiliary False Positive table in 286, but during a read or before a write, the False Positive table is queried in 276. If the query is unsuccessful, an invalid access is reported in 286. If the query is successful, the access is considered verified valid in 280.

With an approach such as method 260, there is no explicit entropy threshold that needs to be set. The tradeoff is that every memory access requires all tag decryptions.

### Example Apparatuses, Methods, etc.

According to some examples, an apparatus includes a plurality of decryption circuits and an entropy comparison circuit. The plurality of decryption circuits are to decrypt content of a memory location to be referenced by a pointer used in an attempted access to the memory location, the pointer to include a supplied tag value, wherein the supplied tag value is one of a plurality of possible tag values, and wherein each of the plurality of decryption circuits is to decrypt the content of the memory location based on a different one of the plurality of possible tag values to generate a plurality of decryption results. The entropy comparison circuit is to determine whether the attempted access is valid by measuring entropy of at least one of the plurality of decryption results and comparing the entropy of the at least one of the plurality of decryption results to the entropy of at least an other one of the plurality of decryption results or a threshold value.

Any such examples may include any or any combination of the following aspects. The entropy comparison circuit is to measure the entropy based on at least one of a byte collision test, a nibble collision test, and a bit collision test. The attempted access to the memory location is one of a plurality of attempted accesses to a plurality of memory locations, wherein each of the plurality of memory locations is of a fixed size. Each of the plurality of memory locations is to be assigned one of the plurality of possible tag values. The threshold value is to be determined based on tuning parameters including at least one of the fixed size and a maximum number of possible tag values. If the attempted access is a write of data that would result in a subsequent valid read access being determined invalid by the entropy comparison circuit, the supplied tag value and an address of the memory location is to be stored in a lookup table to be referenced during the subsequent valid read access.

According to some examples, a method includes decrypting content of a memory location referenced by a pointer used in an attempted access to the memory location, the pointer including a supplied tag value, wherein the supplied tag value is one of a plurality of possible tag values and wherein the decrypting is performed based on the supplied tag value; measuring entropy of at least one of a plurality of decryption results; and determining whether the attempted access is valid by comparing the entropy of a result of the decrypting to the entropy of a result of decrypting based on at least an other one of the plurality of possible tag values or a threshold value.

Any such examples may include any or any combination of the following aspects. The attempted access is determined to be valid if the entropy of the result of the decrypting based on the supplied tag value is low compared to the entropy of the result of the decrypting based on the at least the other of the possible tag values. If the entropy of the result of the decrypting based on the supplied tag value is high compared to the entropy of the result of the decrypting based on the at least the other of the possible tag values, the method also includes querying a false positive table for the supplied tag value and an address of the memory location. The method also includes determining the attempted access is valid if the supplied tag value and the address of the memory location are found in the false positive table. The method also includes determining the access is invalid if the supplied tag value and the address of the memory location are not found in the false positive table. Decrypting based on at least an other one of the plurality of possible tag values is performed in parallel with decrypting based on the supplied tag value. Decrypting based on at least an other one of the plurality of possible tag values is performed after decrypting based on the supplied tag value, only if the entropy of the result of the decrypting based on the supplied tag value is high compared to the threshold. The entropy is measured based on at least one of a byte collision test, a nibble collision test, and a bit collision test. The attempted access to the memory location is one of a plurality of attempted accesses to a plurality of memory locations, wherein each of the plurality of memory locations is of a fixed size. Each of the plurality of memory locations is assigned one of the plurality of possible tag values. The threshold value is determined based on tuning parameters including at least one of the fixed size and a maximum number of possible tag values.

According to some examples, an apparatus may include means for performing any function disclosed herein; an apparatus may include a data storage device that stores code that when executed by a hardware processor or controller causes the hardware processor or controller to perform any method or portion of a method disclosed herein; an apparatus, method, system etc. may be as described in the detailed description; a non-transitory machine-readable medium may store instructions that when executed by a machine causes the machine to perform any method or portion of a method disclosed herein. Embodiments may include any details, features, etc. or combinations of details, features, etc. described in this specification.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, the first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 470 or 480, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor, or special-purpose processor, such as, for example, a network or communication processor, compression engine, graphics processor, GPGPU (general purpose graphics processing unit), a high throughput many integrated cores (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller unit circuitry 516 couples the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

### Example Core Architectures—In-Order and Out-of-Order Core Block Diagram

FIG. 6A is a block diagram illustrating both an example in-order pipeline and an example register renaming, out-of-order issue/execution pipeline according to examples. FIG. 6B is a block diagram illustrating both an example in-order architecture core and an example register renaming, out-of-order issue/execution architecture core to be included in a processor according to examples. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, an optional length decoding stage 604, a decode stage 606, an optional allocation (Alloc) stage 608, an optional renaming stage 610, a schedule (also known as a dispatch or issue) stage 612, an optional register read/memory read stage 614, an execute stage 616, a write back/memory write stage 618, an optional exception handling stage 622, and an optional commit stage 624. One or more operations can be performed in each of these processor pipeline stages. For example, during the fetch stage 602, one or more instructions are fetched from instruction memory, and during the decode stage 606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 606 and the register read/memory read stage 614 may be combined into one pipeline stage. In one example, during the execute stage 616, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 6B may implement the pipeline 600 as follows: 1) the instruction fetch circuitry 638 performs the fetch and length decoding stages 602 and 604; 2) the decode circuitry 640 performs the decode stage 606; 3) the rename/allocator unit circuitry 652 performs the allocation stage 608 and renaming stage 610; 4) the scheduler(s) circuitry 656 performs the schedule stage 612; 5) the physical register file(s) circuitry 658 and the memory unit circuitry 670 perform the register read/memory read stage 614; the execution cluster(s) 660 perform the execute stage 616; 6) the memory unit circuitry 670 and the physical register file(s) circuitry 658 perform the write back/memory write stage 618; 7) various circuitry may be involved in the exception handling stage 622; and 8) the retirement unit circuitry 654 and the physical register file(s) circuitry 658 perform the commit stage 624.

FIG. 6B shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3 (L3) cache circuitry (not shown), and/or main memory. The L2 cache circuitry 676 is coupled to one or more other levels of cache and eventually to a main memory.

The core 690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 690 includes logic to support a packed data instruction set architecture extension (e.g., AVX1, AVX2), thereby allowing the operations used by many multimedia applications to be performed using packed data.

### Example Execution Unit(s) Circuitry

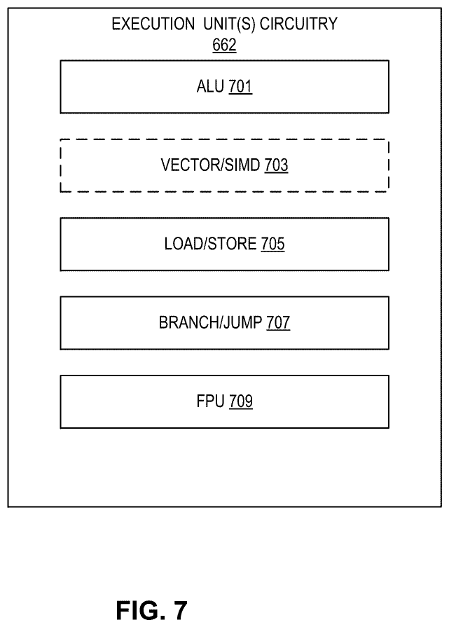

FIG. 7 illustrates examples of execution unit(s) circuitry, such as execution unit(s) circuitry 662 of FIG. 6B. As illustrated, execution unit(s) circuity 662 may include one or more ALU circuits 701, optional vector/single instruction multiple data (SIMD) circuits 703, load/store circuits 705, branch/jump circuits 707, and/or Floating-point unit (FPU) circuits 709. ALU circuits 701 perform integer arithmetic and/or Boolean operations. Vector/SIMD circuits 703 perform vector/SIMD operations on packed data (such as SIMD/vector registers). Load/store circuits 705 execute load and store instructions to load data from memory into registers or store from registers to memory. Load/store circuits 705 may also generate addresses. Branch/jump circuits 707 cause a branch or jump to a memory address depending on the instruction. FPU circuits 709 perform floating-point arithmetic. The width of the execution unit(s) circuitry 662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

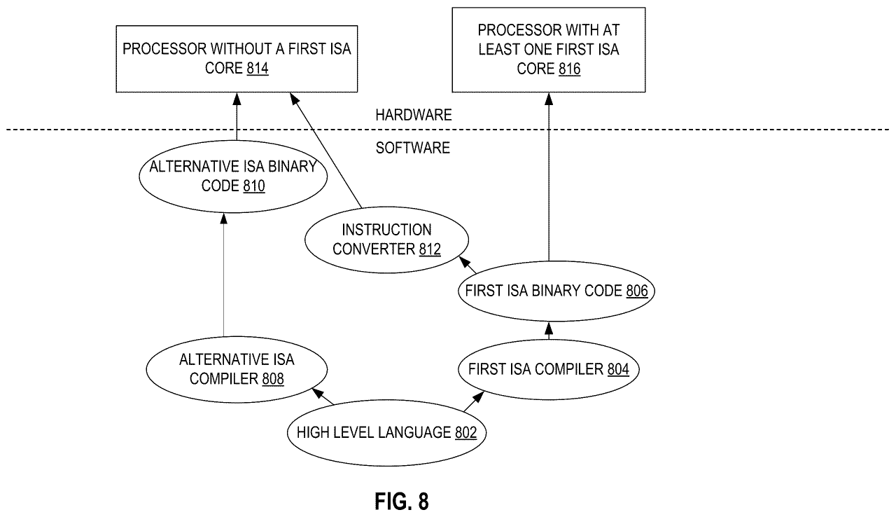

FIG. 8 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 8 shows a program in a high-level language 802 may be compiled using a first ISA compiler 804 to generate first ISA binary code 806 that may be natively executed by a processor with at least one first ISA core 816. The processor with at least one first ISA core 816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 804 represents a compiler that is operable to generate first ISA binary code 806 (e.g., object code) that can, with or without additional linkage processing, be executed on the processor with at least one first ISA core 816. Similarly, FIG. 8 shows the program in the high-level language 802 may be compiled using an alternative ISA compiler 808 to generate alternative ISA binary code 810 that may be natively executed by a processor without a first ISA core 814. The instruction converter 812 is used to convert the first ISA binary code 806 into code that may be natively executed by the processor without a first ISA core 814. This converted code is not necessarily to be the same as the alternative ISA binary code 810; however, the converted code will accomplish the general operation and be made up of instructions from the alternative ISA. Thus, the instruction converter 812 represents software, firmware, hardware, or a combination thereof that, through emulation, simulation, or any other process, allows a processor or other electronic device that does not have a first ISA processor or core to execute the first ISA binary code 806.

References to “one example,” “an example,” “one embodiment,” “an embodiment,” etc., indicate that the example or embodiment described may include a particular feature, structure, or characteristic, but every example or embodiment may not necessarily include the particular feature, structure, or characteristic. Moreover, such phrases do not necessarily refer to the same example or embodiment. Further, when a particular feature, structure, or characteristic is described in connection with an example or embodiment, it is submitted that it is within the knowledge of one skilled in the art to affect such feature, structure, or characteristic in connection with other examples or embodiments whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C). As used in this specification and the claims and unless otherwise specified, the use of the ordinal adjectives “first,” “second,” “third,” etc. to describe an element merely indicates that a particular instance of an element or different instances of like elements are being referred to and is not intended to imply that the elements so described must be in a particular sequence, either temporally, spatially, in ranking, or in any other manner. Also, as used in descriptions of embodiments, a “/” character between terms may mean that what is described may include or be implemented using, with, and/or according to the first term and/or the second term (and/or any other additional terms).

Also, the terms “bit,” “flag,” “field,” “entry,” “indicator,” etc., may be used to describe any type or content of a storage location in a register, table, database, or other data structure, whether implemented in hardware or software, but are not meant to limit embodiments to any particular type of storage location or number of bits or other elements within any particular storage location. For example, the term “bit” may be used to refer to a bit position within a register and/or data stored or to be stored in that bit position. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments to any particular logical convention, as any logical convention may be used within embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a plurality of decryption circuits to decrypt content of a memory location to be referenced by a pointer used in an attempted access to the memory location, the pointer to include a supplied tag value, wherein the supplied tag value is one of a plurality of possible tag values, and wherein each of the plurality of decryption circuits is to decrypt the content of the memory location based on a different one of the plurality of possible tag values to generate a plurality of decryption results; and
an entropy comparison circuit to determine whether the attempted access is valid by measuring entropy of at least one of the plurality of decryption results and comparing the entropy of the at least one of the plurality of decryption results to the entropy of at least an other one of the plurality of decryption results or a threshold value.

2. The apparatus of claim 1, wherein the entropy comparison circuit is to measure the entropy based on at least one of a byte collision test, a nibble collision test, and a bit collision test.

3. The apparatus of claim 1, wherein the attempted access to the memory location is one of a plurality of attempted accesses to a plurality of memory locations, wherein each of the plurality of memory locations is of a fixed size.

4. The apparatus of claim 3, wherein each of the plurality of memory locations is to be assigned one of the plurality of possible tag values.

5. The apparatus of claim 3, wherein the threshold value is to be determined based on tuning parameters including at least one of the fixed size and a maximum number of possible tag values.

6. The apparatus of claim 1, wherein if the attempted access is a write of data that would result in a subsequent valid read access being determined invalid by the entropy comparison circuit, the supplied tag value and an address of the memory location is to be stored in a lookup table to be referenced during the subsequent valid read access.

7. A method comprising:
decrypting content of a memory location referenced by a pointer used in an attempted access to the memory location, the pointer including a supplied tag value, wherein the supplied tag value is one of a plurality of possible tag values and wherein the decrypting is performed based on the supplied tag value;
measuring entropy of at least one of a plurality of decryption results; and
determining whether the attempted access is valid by comparing the entropy of a result of the decrypting to the entropy of a result of decrypting based on at least an other one of the plurality of possible tag values or a threshold value.

8. The method of claim 7, wherein the attempted access is determined to be valid if the entropy of the result of the decrypting based on the supplied tag value is low compared to the entropy of the result of the decrypting based on the at least the other of the possible tag values.

9. The method of claim 7, further comprising, if the entropy of the result of the decrypting based on the supplied tag value is high compared to the entropy of the result of the decrypting based on the at least the other of the possible tag values, querying a false positive table for the supplied tag value and an address of the memory location.

10. The method of claim 9, further comprising determining the access is valid if the supplied tag value and the address of the memory location are found in the false positive table.

11. The method of claim 9, further comprising determining the attempted access is invalid if the supplied tag value and the address of the memory location are not found in the false positive table.

12. The method of claim 7, wherein decrypting based on at least an other one of the plurality of possible tag values is performed in parallel with decrypting based on the supplied tag value.

13. The method of claim 7, wherein decrypting based on at least an other one of the plurality of possible tag values is performed after decrypting based on the supplied tag value, only if the entropy of the result of the decrypting based on the supplied tag value is high compared to the threshold.

14. The method of claim 7, wherein the entropy is measured based on at least one of a byte collision test, a nibble collision test, and a bit collision test.

15. The method of claim 7, wherein the attempted access to the memory location is one of a plurality of attempted accesses to a plurality of memory locations, wherein each of the plurality of memory locations is of a fixed size.

16. The method of claim 15, wherein each of the plurality of memory locations is assigned one of the plurality of possible tag values.

17. The method of claim 15, wherein the threshold value is determined based on tuning parameters including at least one of the fixed size and a maximum number of possible tag values.

18. A non-transitory machine-readable medium storing instructions which, when executed by a machine, causes the machine to perform a method comprising:
decrypting content of a memory location referenced by a pointer used in an attempted access to the memory location, the pointer including a supplied tag value, wherein the supplied tag value is one of a plurality of possible tag values and wherein the decrypting is performed based on the supplied tag value;
measuring entropy of at least one of a plurality of decryption results; and
determining whether the attempted access is valid by comparing the entropy of a result of the decrypting to the entropy of a result of decrypting based on at least an other one of the plurality of possible tag values or a threshold value.

19. The non-transitory machine-readable medium of claim 18, wherein the attempted access is determined to be valid if the entropy of the result of the decrypting based on the supplied tag value is low compared to the entropy of the result of the decrypting based on the at least the other of the possible tag values.

20. The non-transitory machine-readable medium of claim 18, wherein the method further comprises, if the entropy of the result of the decrypting based on the supplied tag value is high compared to the entropy of the result of the decrypting based on the at least the other of the possible tag values, querying a false positive table for the supplied tag value and an address of the memory location.
